(19) United States
(12) Patent Application Publication
(10) Pub. No.: US 2016/0369124 A1
(43) Pub. Date: Dec. 22, 2016

(54) TRANSITION METAL PROPPANTS

(71) Applicant: TECHNISAND, INC., Chesterland, OH (US)

(72) Inventor: Syed Akbar, Richmond, TX (US)

(21) Appl. No.: 15/228,189

(22) Filed: Aug. 4, 2016

Related U.S. Application Data
(62) Division of application No. 13/499,387, filed on Nov. 7, 2012.
(60) Provisional application No. 61/248,024, filed on Oct. 2, 2009.

(51) Int. Cl. C09D 161/14; C09K 8/80

(52) U.S. Cl. CPC C09D 161/14; C09K 8/805

(57) ABSTRACT

A meta crosslinked polar benzyl polymer is made by combining a transition metal crosslinker, or one or more source compounds capable of reacting to form such a transition metal crosslinker, with a polar benzyl polymer which has been activated for meta crosslinking.

### CROSS-REFERENCE TO RELATED APPLICATION

This application claims the benefit of U.S. Provisional Patent Application Ser. No. 61/248,024, entitled META CROSSLINKED BENZYL POLYMERS and filed Oct. 2, 2009, the entire disclosure of which is incorporated herein by reference, to the extent that it is not conflicting with the present application.

### BACKGROUND

Phenolic resins are a well known class of synthetic resins which are made by reacting phenol or substituted phenol with an aldehyde, especially formaldehyde. See, Phenolic Resins, Vol. 11, Encyclopedia of Polymer Science and Engineering, © 1988, John Wiley & Sons, Inc.

### Novolac Resins

There are two basic varieties of phenolic resins, novolacs and resoles. Novolacs are thermoplastic resins which are made by reacting a deficiency of aldehyde with the phenol component in the presence of an acid catalyst. FIG. 1 illustrates the chemical structure of various novolac oligomers having 4 to 12 phenol units, while FIG. 2 is another representation of the structure of a conventional novolac resin. As shown in these figures, these materials are composed of multiple phenol groups which are linked to one another at their ortho and para positions by methylene “bridges” or linkages (—CH₂—). Such linkages are not formed at the meta positions of these phenol moieties. Note, also, that while a relatively few of the phenol groups in these oligomers have all three of their ortho and para positions occupied, most do not.

In commercial practice, most novolac resins have molecular weights on the order of about 500 to 5,000. Therefore, it will be appreciated that such commercial novolac resins normally include roughly about 9 to 50 phenol moieties which are linked to one another generally in the manner illustrated in FIGS. 1 and 2. In commerce, these resins are known as “A stage” resins, which connotes that these novolacs are still thermoplastic in nature.

In use, most novolacs are ultimately cured into thermoset resins, the so-called “B-stage” resins, by adding additional amounts of aldehyde. This is typically done by adding “hexa” (i.e., hexamethylene tetramine), which decomposes at elevated temperature to yield formaldehyde and ammonia. This additional aldehyde, in turn, reacts to form additional methylene linkages at the remaining unoccupied ortho and para positions. The ultimate result is a fully cured resin in which most or essentially all of the ortho and para positions are occupied by methylene linkages. All of the meta positions, however, remain unoccupied, as methylene linkages do not form at these sites.

### Resole Resins

Resole resins differ from novolacs in that resole resins are made with an excess rather than a deficiency of aldehyde in the presence of an alkaline rather than an acidic catalyst. This causes a somewhat different reaction mechanism to occur, which results in resoles being thermosetting in nature. That is to say, the two-step reaction scheme that occurs when novolacs are created in a first reaction step and then cured in a second reaction step is replaced by a one-step reaction scheme in which creation and curing of the resin occur simultaneously. However, once the reaction is completed, the cured thermoset reaction product obtained has essentially the same chemical structure as its novolac counterpart, i.e., a matrix of interconnected phenol moieties in which most or essentially all of the ortho and para positions are occupied by methylene linkages, while none of the meta positions are occupied because methylene linkages do not form at these sites.

### SUMMARY

In accordance with this invention, the phenolic moieties of these and other benzyl polymers are crosslinked at their meta positions by means of a transition metal crosslinker, this being done by combining the transition metal crosslinker or a source compound capable of reacting to form this transition metal crosslinker with a benzyl polymer which has been suitably activated for meta crosslinking.

Thus, this invention provides a new polymer material comprising a meta crosslinked. polar benzyl polymer in which the meta crosslinks contain a transition metal.

In addition, this invention provides a new process for making this meta crosslinked polar benzyl polymer comprising combining a transition metal crosslinker, or one or more source compounds capable of reacting to form such a transition metal crosslinker, with a meta activated polar benzyl polymer incompletely crosslinked at its ortho and para positions.

In addition, this invention further provides a new resin coated proppant comprising a proppant particle substrate coated with a meta crosslinked polar benzyl polymer in which the meta crosslinks contain a transition metal.

Furthermore, this invention also provides a new material comprising the residue obtained when a meta crosslinked polar benzyl polymer made with inorganic meta crosslinks as described above is heated under conditions severe enough to decompose the resin.

Finally, this invention also provides a new proppant material comprising a proppant particle substrate carrying a surface coating comprising a meta crosslinked polar benzyl polymer decomposition residue, this decomposition residue being produced by heating a meta crosslinked polar benzyl polymer made with inorganic meta crosslinks containing a transition metal under conditions severe enough to decompose the resin.

### BRIEF DESCRIPTION OF THE DRAWINGS

FIG. 1 shows the chemical structure of different novolac oligomers having 4 to 12 phenol units.

FIG. 2 is another representation of the chemical structure of a conventional novolac polymer.

FIGS. 3a to 3f identify specific compounds that can be used to form the organic meta crosslinks of this invention.

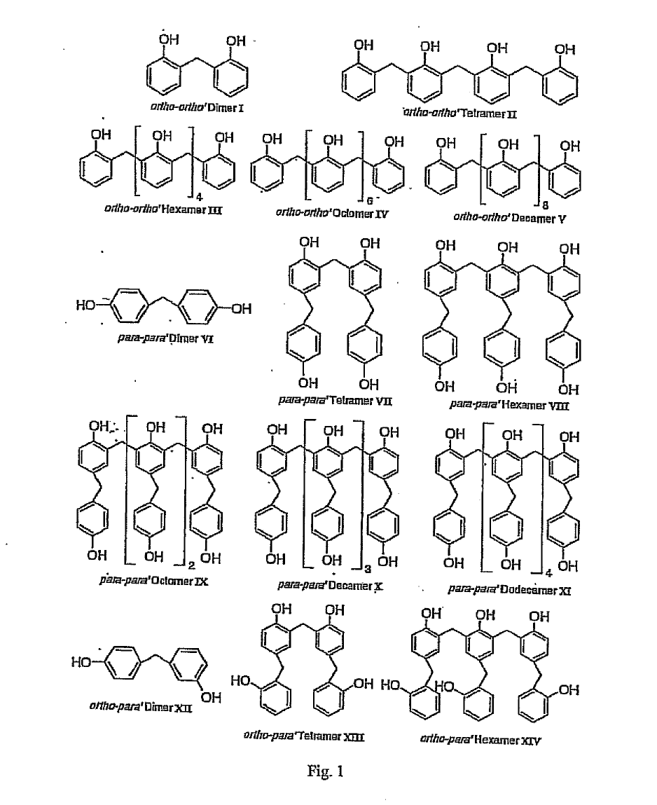

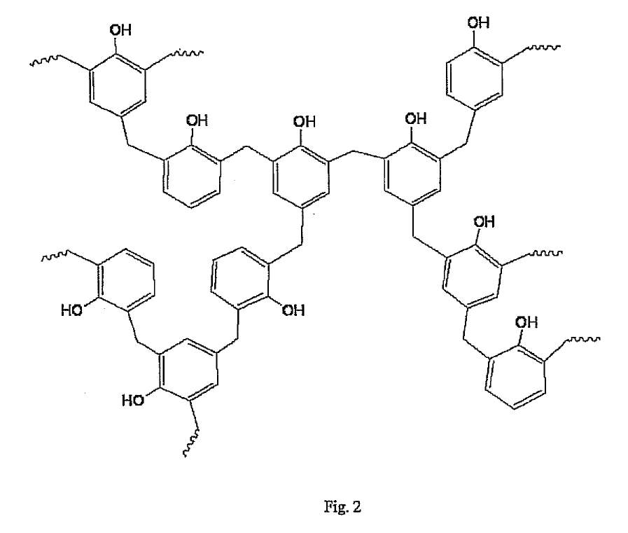

### DETAILED DESCRIPTION

In accordance with this invention, certain polar benzyl polymers which have been meta activated in the manner described below are crosslinked in their meta positions by means of a transition metal containing crosslinker, or a source compound capable of reacting to form such a transition metal containing crosslinker.

### Resins

The primary focus of this invention is on phenolic resins, especially novolacs and resoles as described above. Thus, this invention is applicable to any type of phenolic resin which is made by reacting a phenol or substituted phenol with any type of aldehyde, provided that at least some of the ortho and para positions of this phenolic resin are unsubstituted.

For this purpose, any phenol or substituted phenol which has previously been used, or which may be used in the future, for making phenolic resins can be used to make the phenolic resins of this invention. Similarly, any aldehyde which has previously been used, or which may be used in the future, for making phenolic resins can be used to make the phenolic resins of this invention. See, the above-mentioned discussion of Phenolic Resins in the Encyclopedia of Polymer Science and Engineering, which not only describes these ingredients in detail but also describes other type of phenolic resins, e.g., specialty resins that are not novolacs or resoles, to which this invention can be applied.

In accordance with this invention, a technique has been developed for activating such phenolic resins for meta substitution, provided that at least some of the ortho and para positions of the phenol groups in these phenolic resins remain uncrosslinked.

In this regard, it is already known that the phenol group of a benzyl ring-containing polymer provides a certain resonance effect on the electron density of the benzyl ring, stabilizing this electron density with a higher concentration at the ring's ortho and para positions and a corresponding lower amount at the ring's meta positions. See, John McMurray, Organic Chemistry, Cornell University Press, © 1992, Chapter 16, pp 577-590. In addition, it is also known that the methylene groups (—CH₂—) which link adjacent phenol groups to one another at their ortho and para positions in a conventional phenolic resin reinforce and enhance this stabilizing effect. See, Gardziella, Pilato and Knop, Phenolic Resins, 2nd Edition, © 2000, Chapter 2.

In accordance with this invention, techniques have been developed to disrupt this resonance stability, thereby activating the benzyl rings for meta substitution, but only if the ortho and para positions of these benzyl rings are not completely substituted with methylene or analogous crosslinks. That is to say, these activating techniques are effective only if some of the ortho and/or para positions of these benzyl rings remain unsubstituted with methylene or other analogous crosslinks. “Analogous” in this context refers to the fact that aldehydes other than formaldehyde can be used to make phenol aldehyde resins, and if so the linkages formed by these other aldehydes will be analogous to the methylene groups formed by formaldehyde.

Thus, this invention is applicable to any type of phenolic resin, provided that at least some of the ortho and/or para positions of its benzyl rings (i.e., at least some of its ortho positions, or at least some of its para positions, or both) remain unsubstituted with methylene or other analogous crosslinks. For convenience, benzyl rings in which at least some of their ortho and/or para positions remain unsubstituted with methylene or other analogous crosslinks are referred to in this document as being “incompletely crosslinked in their ortho and para positions.”

Normally, this invention will be practiced on a conventional “A-stage” novolac resin in which roughly two thirds (˜60% to ˜70%) of the polymer's ortho and para carbon atoms are substituted with methylene or analogous crosslinks. That is to say, roughly two thirds of all the ortho and para carbon atoms in a conventional “A-stage” novolac resin are normally substituted with these crosslinks. However, this invention can also be practiced on phenol aldehyde resins in which a greater proportion of the ortho and para carbon atoms in the polymer are occupied with methylene or analogous crosslinks.

For example, this invention can also be practiced on phenol aldehyde resins in which the degree of incomplete crosslinking of such resins is as low as 2%. That is to say, this invention can also be practiced on phenol aldehyde resins in which only 2% of all the ortho and para carbon atoms in such a resin as a whole remain uncrosslinked. However, because the effect of this invention diminishes as the degree ortho and para crosslinking approaches 100%, this invention will more typically be practiced on phenol aldehyde resins in which the degree of incomplete crosslinking is at least 5%, at least 10%, at least 15%, at least 20%, at least 25%, or even at least 30%.

Although the primary focus of this invention is on phenolic resins, this invention is also applicable to other analogous polymer resins, i.e., benzyl ring-containing polymer resins in which another highly electronegative group replaces the hydroxyl phenol. Accordingly, any other benzyl ring-containing resin in which the benzyl ring is substituted with a substituent that provides the same kind of electron density stabilization as occurs in a phenolic resin can also be meta crosslinked in accordance with this invention. Thus, benzyl ring containing polymers in which the benzyl ring is substituted with nitro, amino, sulfone, sulfonyl, other polar functional group, or C₁-C₈ alkyls substituted with any of these polar groups, instead of hydroxyl groups, can also be meta crosslinked in accordance with this invention, it is believed. For ease of description, all of these polymers and copolymers are referred to in this document as “polar benzyl polymers.”

Thus in accordance with this invention, any polar benzyl polymer which is incompletely crosslinked at its ortho and para positions can be meta crosslinked by the technology of this invention.

### Transition Metal Meta Crosslinkers

In accordance with this invention, crosslinks are formed at the meta positions of the benzyl groups in these polar benzyl polymers by reacting the polymer with a transition metal crosslinker.

Suitable transition metals which can be used for this purpose include those elements in Periods 3 to 7 of the Periodic Table of the Elements which are capable of adopting at least three different coordination states. These include Al, Ti, V, Cr, Mn, Co, Ni, Ga, Ge, Y, Zr, Nb, Mo, Tc Ru, Rh, Pd, Ag, Cd, In, Sn, Sb, La, Ce, Pr and the other lanthanides, Hf, Ta, W, Re, Os, Ir, Pt, Au, Hg, Tl, Pb, Bi, Po, Ac, Th and the other actinides. Preferred transition metals are those in Periods 3, 4 and 5 of the Periodic Table as well as those in the lanthanide series.

Some of these elements work better than others, while some are advantageously used in combination to provide better activity. For example, Zn and Ge work better in combination, especially as germanium dioxide plus zinc pyrophosphate. Preferred transition metals include Sb, P, Mo, S, W, Zr, Ti, Mn, Cr, V, Rh and Al, for example.

### Transition Metal Meta Crosslinker-Organic

The transition metal meta crosslinks of this invention can be organic as well as inorganic.

Compounds that can be used to form organic meta crosslinks in accordance with this invention include any organometallic compound which contains a transition metal in a valence state of at least four. In such compounds, a separate organic moiety will normally be attached to the transition metal for each valence state. For example, where the transition metal has a valence state of four, four separate organic moieties will be attached to the transition metal each by its own single (sigma) chemical bond. In some instances, however, (such as in the chelate-type compounds discussed below), a single organic moiety may be attached to the transition metal by two separate single (sigma) chemical bonds.

These organic moieties can be attached directly to the transition metal (i.e., by a carbon-metal) bond, if desired. However, normally these organic moieties are attached to the transition metals via an intermediate oxygen atom, as this is the most convenient way of attaching multiple organic moieties to a central, coordinating transition metal. Thus, these organic moieties will most commonly be alkoxy, in those cases in which the organic radical of this moiety is alkyl. More broadly, these organic moieties can be any “oxyorgano” moiety, i.e., any moiety of the general formula —OR where R is any type of organic radical.

Examples of suitable oxyorgano moieties include —OR groups in which R is an unsubstituted C₁-C₁₂ alkyl such as methyl, ethyl, propyl, isopropyl, butyl, pentyl, hexyl, heptyl, octyl, 2-ethyl hexyl and the like.

Other examples of suitable —OR groups include
ethoxy substituted alkoxy such as those having the formula O(C₂H₄O), CH₃ where n is 1-12,
carboxylic acid moieties such as OCOR¹ where R¹ is C₁-C₂₄ alkyl (such as isostearoyl, caproyl and neodecanoyl) or R¹ is unsaturated (such as acryl or methacryl),
sulfonic acid moieties such as OSO₂R³ where R³ can be an unsubstituted hydrocarbyl group (such as dodecylbenzenesulfonyl) or a substituted hydrocarbyl group (such as paraaminobenzenesulfonyl),
phosphoric acid moieties such as OPO₃R⁴₂ where R⁴ is the same or different hydrocarbyl group (such as dioctylphosphato),
pyrophosphoric acid moieties such as OP₂O₆HR⁵₂ where R⁵ is the same or different hydrocarbyl group (such as dioctylpyrophosphato),
phosphito moieties such as OPH(OR⁶)₂ where R⁶ can be unsubstituted or substituted alkyl having 2-24 carbon atoms (such as dioctyl phosphito or ditridecylphosphito),
amino substituted alkyls (such as N-ethylenediaminoethyl),
neoalkoxy moieties having 10-24 carbon atoms (such as neopentyl(diallyl)oxy [2-(CH₂═CH—CH₂)₂CH₃CH₂CCH₂O—], and
benzyloxy moieties such as OR⁷ where R⁷ is an unsubstituted or substituted aromatic group substituted with P, O or S (such as m-aminophenyl).
   In those moieties having pendent alkyl groups, it is also contemplated that such alkyl groups can include epoxy linkages (such as 9,10 epoxy stearoyl).

Still other examples of suitable —OR groups include chelate type moieties in which two oxygen atoms of the moiety are attached to the transition metal (more specifically moieties of the formula OOR⁸ in which both oxygen atoms are attached to the transition metal) where R⁸ can be unsubstituted or substituted alkyl having 2-6 carbon atoms (such as ethylene, i.e., OOC₂H₄, or oxoethylene, i.e., OOC₂R₂O)

Compounds which are suitable for use in forming the transition metal organic crosslinks of this invention and which contain these and other moieties are more thoroughly described in the Ken-React Reference Manual—Titanate, Zirconate and Aluminate Coupling Agents authored by Salvatore J. Monte and publish by Kenrich Petrochemicals, Inc. of Bayonne, N.J. in February, 1985, the disclosure of which is incorporated herein by reference.

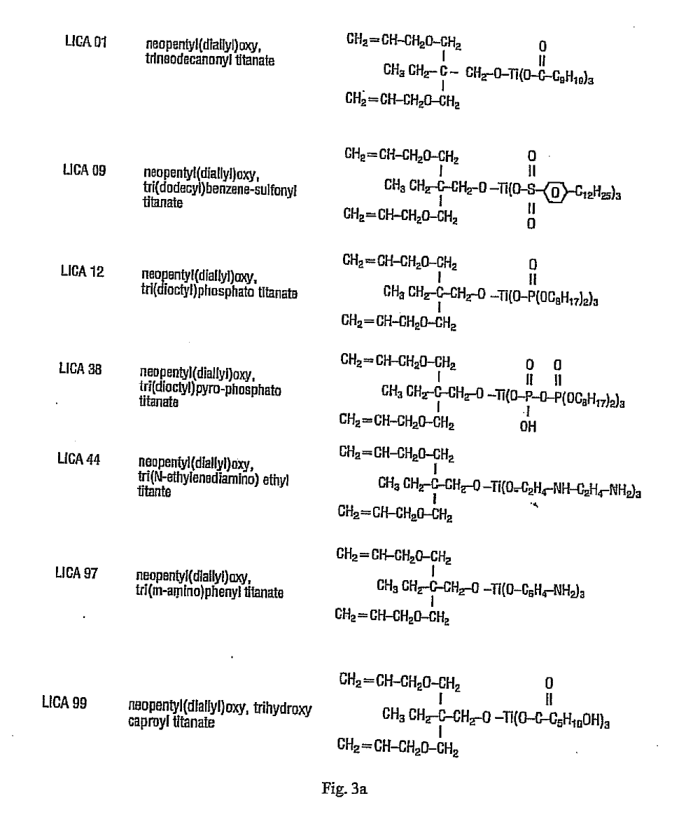

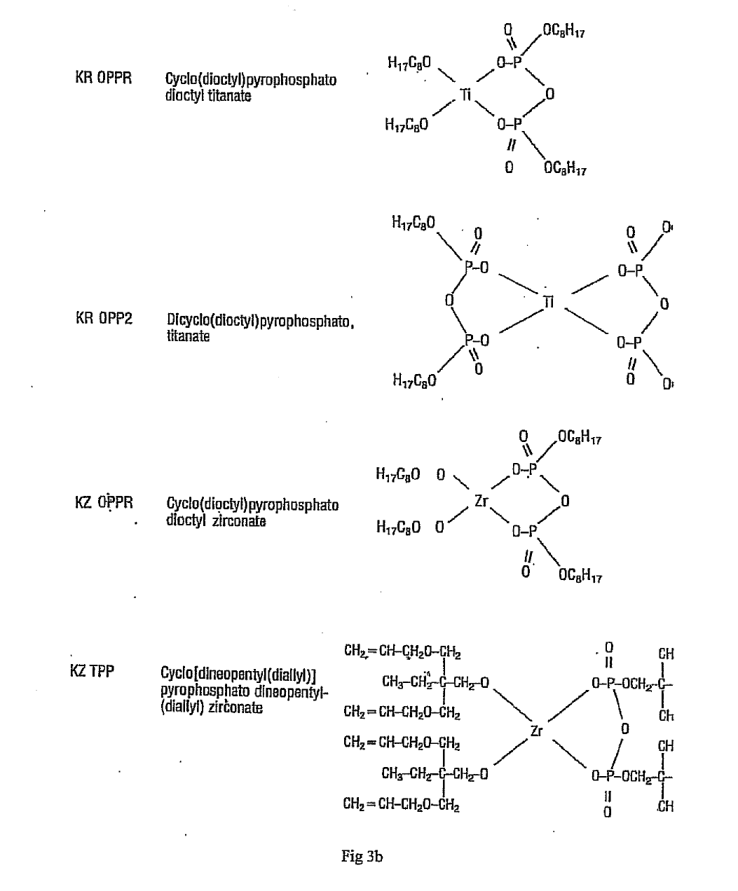

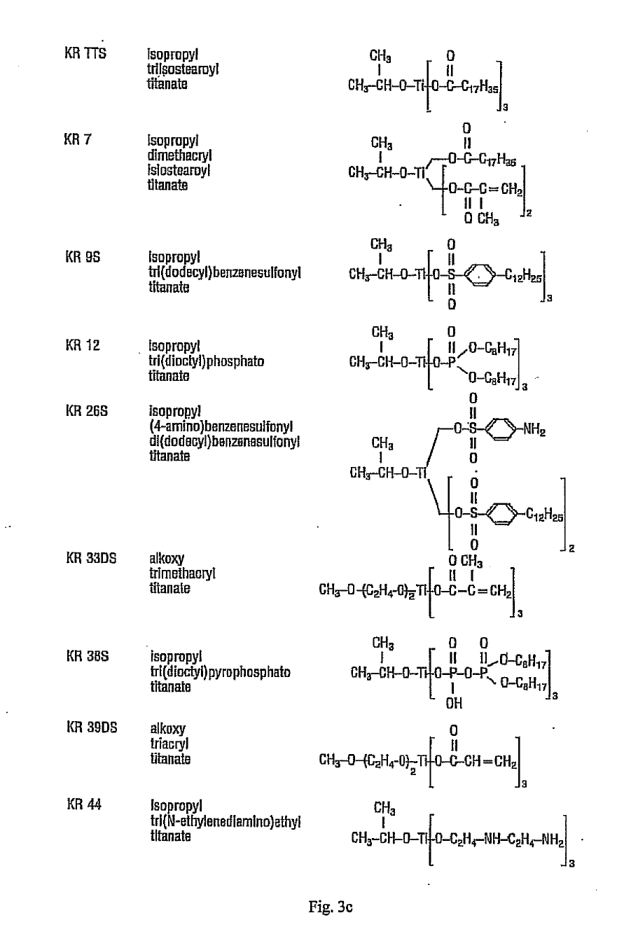

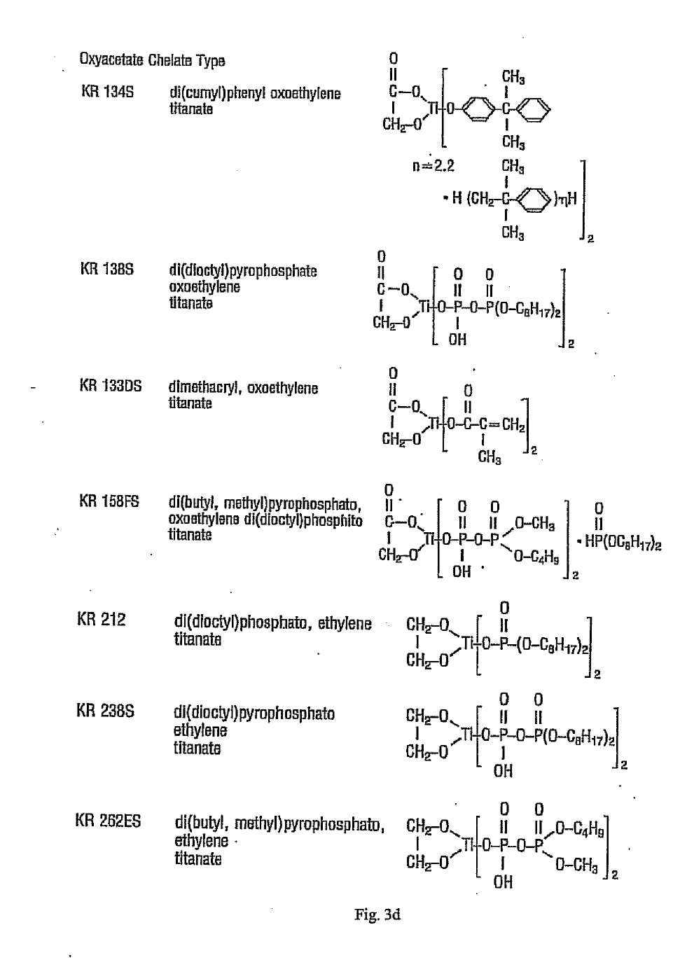

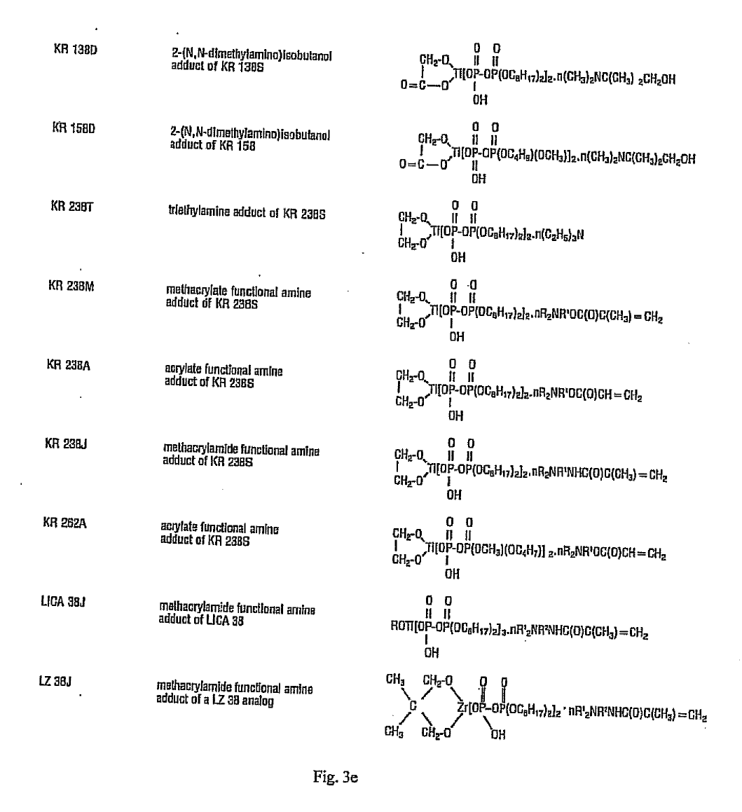

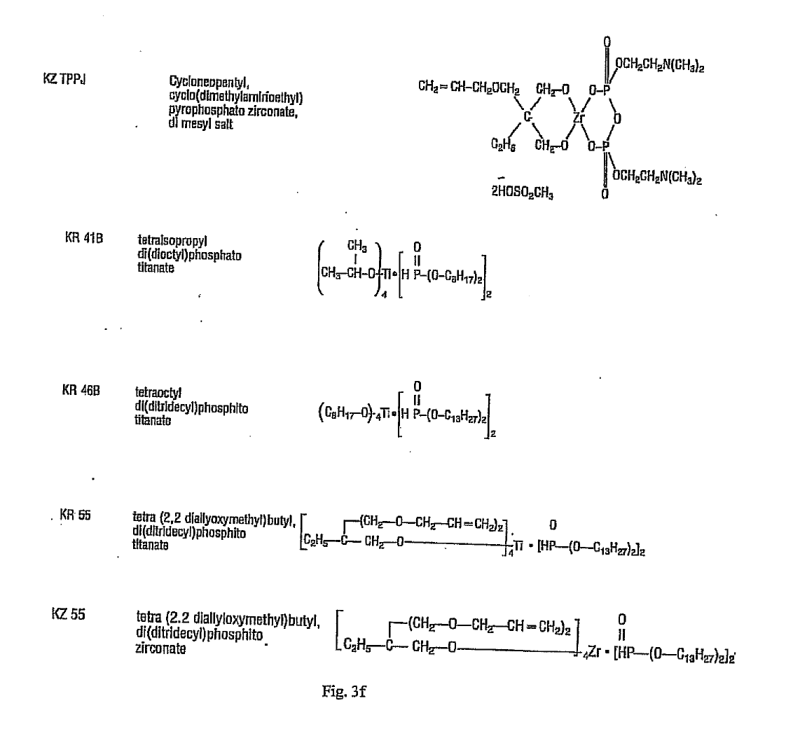

Specific examples of such compounds are shown in attached FIGS. 3a, 3b, 3c, 3d, 3e and 3f.

Note from above that in many embodiments of this invention, at least one organic moiety in the compound forming this organic meta crosslink also contains an additional highly electronegative elements such as N, S and additional O, as this has been found to further enhance the meta crosslinking provided by this invention in many instances.

Note also that in many embodiments of this invention, the transition metal of the meta crosslinker is part of a central core in which the transition metal is surrounded by and attached directly to multiple oxygen atoms, most often four oxygen atoms. In effect, therefore, the transition metal in these meta crosslinkers forms a “metalate” central core (e.g., an antimonate, phosphate, molybdate, sulfate, tungstate, manganate, chromate, vanadate, rhutenate, niobate, aluminate, zirconate, yttrate, stannate, thorate), which metalate central core is highly electronegative in nature due to the combined effects of the transition metal plus the multiple oxygen atoms.

In accordance with this invention, it has been found that these transition metal containing compounds will form meta crosslinks between the meta carbon atoms of “adjacent” benzyl groups in an polar benzyl polymer, provided that these meta carbon atoms are suitably activated as further discussed below. Although not wishing to be bound to any theory, it is believed that this meta crosslinking occurs due to the ability of the transition metal core of these crosslinkers to draw electrons away from the more remote portions of the crosslinker.

In particular, it is believed that the transition metal operates to draw electrons away from the distal carbon atoms of the crosslinker's organic moieties. In those instances in which the organic moiety includes one or more highly electronegative elements such as O, and/or S, this effect becomes even more pronounced. As a result of this drawing away of electrons, these distal carbon atoms become more electropositive. This, in turn, causes these distal carbon atoms to be attracted to and bond with the meta carbon atoms of the polar benzyl polymer, but only because these meta carbon atoms have been suitably activated for bonding as further discussed below.

### Transition Metal Meta Crosslinker-Inorganic

The inorganic transition metal crosslinks of this invention can be viewed as comprising rare earth element end portions and a transition metal core. Normally, each rare earth element end portion will be bound to the transition metal core by one or more O, N, S or other highly electronegative atoms.

Transition metals useful for this purpose include all of the transition metals described above. Transition metals having atomic numbers of 13-51 and 72-84 are desirable, while Sb, Mo, W, Mn, Cr, V and Rh are more interesting. Antimony, molybdenum, zinc and aluminum are especially interesting. The rare earth elements which are useful for this purpose include all of the lanthanide series elements as well as all of the actinide series elements. Thus, La, Ce, Pr, Nd, Pm, Sm, Eu, Gd, Tb, Dy, Ho, Er, Tm, Yb, Lu Ac, Th, Pa, U, Np, Pu, Am, Cm, Bk, Cf, Es, Fm, Md, No, Lr and mixtures thereof can be used. Lanthanum, cerium and thorium are preferred.

Normally, the inorganic transition metal crosslinks of this invention will be formed in situ by adding a suitable compound containing the transition metal (“transition metal source compound”) and a suitable compound containing the rare earth element (“rare earth source compound”) to the reaction system. Normally, the optional O, N, S or other highly electronegative element which connect the transition metal to the rare earth element will also be supplied by either or both of these source compounds. However, other separate source compounds can be used for this purpose.

Source compounds suitable for supplying transition metals for forming the inorganic transition metal crosslinks of this invention include any inorganic compound which contains a transition metal having at least a divalent state. Examples include
salts in which the anion is a transition “metalate” such as antimonate, phosphate, molybdate, sulfate, tungstate, manganate, chromate, vanadate, rhutenate, niobate, aluminate, zirconate, yttrate, stannate, thorate, with the cation being any monovalent cation (e.g., NH₄, Li, Na, K, Ru, Cs and/or Fr) or divalent cation (e.g., Be, Mg, Ca, Sr, Ba and/or Ra),
salts in which the anion is a transition metalite such as phosphite, sulfite, with the cation being any monovalent cation (e.g., NH₄, Li, Na, K, Ru, Cs and/or Fr) or divalent cation (e.g., Be, Mg, Ca, Sr, Ba and/or Ra),
salts in which the transition metal is present as the cation, e.g., zinc pyrophosphate [Zn₂P₂O₇], with the anion being any anion which will provide the necessary countercharge,
sulfides, e.g., diantimony disulfide, molybdenum disulfide, and
oxides, e.g., germanium dioxide (GeO₂) and rhenium oxide [Rh(VI)O₃].

Combinations of these transition metal source compounds can be used. For example, molybdenum disulfide, zinc pyrophosphate and aluminum phosphate can be used together, as shown in Example 5 below. Another combination of transition metal source compounds which has been found to be useful is germanium oxide plus lithium niobate.

Source compounds suitable for supplying rare earths for forming the inorganic transition metal crosslinks of this invention include the rare earth oxides such as lanthanum oxide, thorium oxide, cerium oxide and lutetium oxide. Other inorganic compounds in which the rare earth element is bonded to a highly electronegative inorganic moiety can also be used for this purpose. For example, nitrates, acetates, citrates and the C₁-C₈ alkoxides of these rare earth elements can also be used.

Note that the inorganic transition metal crosslinks of this invention are similar to the organic transition metal crosslinks of this invention in that both are formed from a transition metal core and two or more end groups, each of which has a highly electropositive element at its distal end. Note also that these inorganic crosslinks, like their organic counterparts, also normally contain additional highly electronegative elements (e.g., O, N and/or S) surrounding the transition metal, which further enhances the electronegative character of this core. Thus, it is believed that essentially the same phenomenon that occurs when organic crosslinks are formed in accordance with this invention also occurs when inorganic crosslinks are formed, i.e., the transition metal plus any O, N and/or S that might be present draw electrons away from the distal ends of the crosslink towards its transition metal center thereby making these distal ends more electropositive for bonding to the activated meta carbon atoms of the polar benzyl polymer.

In the case of these inorganic transition metal crosslinks, however, these crosslinks are normally formed in situ, in the reaction system, rather than beforehand. This is because inorganic compounds which contain transition metal cores and end groups having rare earth or other highly electropositive elements at their distal ends are uncommon, if they exist at all. On the other hand, there is no reason in principle why such compounds could not be used to form the inorganic crosslinks of this invention, if they do indeed exist.

As indicated above, the inorganic crosslinks of this invention are normally formed in situ in the reaction system. This is done by adding the transition metal source compound and the rare earth source compound to the polar benzyl polymer being crosslinked before, or during the time when, the mixture so obtained is at a temperature necessary for the crosslinking reaction to occur, as further discussed below.

### Meta Activation-Influencing the Benzyl Phenol

In accordance with this invention, both organic and inorganic crosslinks can be formed at the meta positions of polar benzyl polymers provided that the carbon atoms at these meta positions are suitably activated.

Activation of these meta carbon atoms can be done in a number of different ways. For example, when the meta crosslinks being formed are organic, this is most easily done by adding a compound containing a rare earth element or other highly electropositive element to the reaction system. For convenience, this compound is referred to herein as a “meta activator.”

All of the rare earth elements, i.e., La, Ce, Pr, Nd, Pm, Sm, Eu, Gd, Tb, Dy, Ho, Er, Tm, Yb, Lu Ac, Th, Pa, U, Np, Pu, Am, Cm, Bk, Cf, Es, Fm, Md, No, Lr and mixtures thereof, can be used for this purpose. Lanthanum, cerium and thorium are preferred.

In order to be effective, the meta activator should also contain at least one highly electronegative element such as O, N and/or S, since these highly electronegative elements further reinforce the electropositive nature of the rare earth element in this compound. Thus, the meta activator of this invention is desirably in the form of an oxide or salt of the above rare earth element. Moreover such salts can be both inorganic and organic. For example, organic salts such as the acetates, formates and citrates can be used. Similarly, inorganic salts such as nitrates, phosphates, phosphites, sulfates and sulfites can be used. Especially interesting meta activators are cerium acetate, cerium nitrate, lanthanum acetate, lanthanum nitrate, thorium acetate and thorium nitrate.

Although not wishing to be bound to any theory, it is believed that the meta activators of this invention activate the meta carbon atoms of the polar benzyl polymer being crosslinked as a result of the influence the rare earth element of the meta activator plays on the phenol group of the polar benzyl polymer. As indicated above, it is already known that the phenol group of a benzyl polymer provides a certain resonance effect on the electron density of the benzyl ring, stabilizing this electron density with a higher concentration at the ring's ortho and para positions and a corresponding lower amount at the ring's meta positions. See, the above-noted McMurray reference text.

In accordance with this invention, it is believed that the rare earth element of the meta activator, because of its highly electropositive nature as well as the O, N and/or S in this compound which further enhances this electropositive effect, disrupts this resonance effect thereby destabilizing the conjugation of the electron density in the benzyl ring. This, in turn, allows a certain portion of this electron density to return to the meta carbon atoms of the ring, making them more electronegative than would otherwise be the case. This, in turn, causes the distal portions the meta crosslinkers to be drawn to and bond with these meta carbon atoms due to the attraction of the now electronegative meta carbon atoms with the highly electropositive distal portions of the meta crosslinkers. In any event, the overall result is that the meta crosslinkers chemically link two or more benzyl groups to one another, meta carbon atom to meta carbon atom, thereby forming meta crosslinks.

### Meta Activation-Modifying the Ortho and/or Para Substituents

Another way the meta carbon atoms can be activated for meta crosslinking in accordance with this invention is by modifying the substituents at the ortho and/or para positions of the benzyl ring of the polymer.

As indicated above, adjacent phenol groups in a conventional phenol formaldehyde resin are linked to one another at their ortho and para positions by methylene linkages, i.e., —CH₂— groups. These methylene linkages are also known to stabilize the electron density of the benzyl ring with a higher concentration at the ring's ortho and para positions and a corresponding lower concentration at the ring's meta positions. See, the above-noted Gardziella et al. reference text. Similar phenol aldehyde resins include analogous linkages.

In accordance with this aspect of the invention, the meta carbon atoms of these and other similar resins can be activated for meta crosslinking by modifying the methylene or other linkages at these ortho and/or para positions to be electronegative in nature.

One way this can be done, for example, is by replacing these methylene or other linkages with amino linkages, i.e., —NH— groups. In this regard, it is well known that when an “A-stage” novolac resin is mixed with hexa (hexamethylenetetramine) and heated to begin its “B-stage” cure, an intermediate product is formed in which the methylene linkages are replaced by amino linkages. See, the above-noted Gardziella et al. reference text, This phenomenon can be used in this aspect of this invention to activate the meta carbon atoms of the polar benzyl polymer to be meta crosslinked by adding hexa or its analog to the reaction system and then heating the system at a temperature which is low enough to cause the hexa or analog to begin decomposing and liberating formaldehyde and ammonia, about 140° F. (60° C.) to 200° F. (˜93° C.), more typically about 150° F. (˜66° C.) to 180° F. (˜82° C.). In this context, an “analog of hexa” will be understood as referring to a compound with acts like hexa in the sense that, in a novolac crosslinking reaction, the compound decomposes under similar conditions as hexa to yield an aldehyde available for crosslinking as well as fugitive ammonia. Such compounds are well known in phenol aldehyde resin technology.

Any other approach which will modify the ortho and/or para substituents of the benzyl ring of such a polar benzyl polymer to be polar in character can also be used to meta activate these polymers.

In accordance with this aspect of this invention, it has been found that making the substituents on the ortho and/or para positions of a polar benzyl polymer electronegative in nature also activates the polymer for meta crosslinking. As in the case of the meta activators described above, it is believed that this phenomenon is also due to a certain disrupting effect that these electronegative substituents have on the electron density of the benzyl rings in these polymers, which as indicated above has been stabilized through the methylene linkages at the ortho and para positions of these rings. Replacing these methylene linkages with amino linkages disrupts this stability, thereby allowing a certain portion of this electron density to return to the meta carbon atoms of the ring, making them more electronegative than would otherwise be the case. This, in turn, causes the distal portions the meta crosslinkers to be drawn to and bond with these meta carbon atoms due to the attraction of the now electronegative meta carbon atoms with the highly electropositive distal portions of the meta crosslinkers. In any event, the overall result is that the meta crosslinkers chemically link two or more benzyl groups to one another, meta carbon atom to meta carbon atom, thereby forming meta crosslinks.

### Ingredient Proportions

The inventive meta crosslinking reaction is essentially stoichiometric in nature. That is to say, each benzyl ring to be meta crosslinked has two meta positions while each crosslinker has two ends available for forming crosslinks. Therefore, the amount of meta crosslinker or precursor (i.e., source compounds yielding transition metals and rare earth elements for forming inorganic meta crosslinks) that should be included in the reaction system should be enough to achieve the amount of meta crosslinking desired. So, for example, if 100% meta crosslinking is desired, the amount of meta crosslinker or precursor and the amount of meta activator that should be included in the system should be at least 100% on a molar basis. Where proportionately less crosslinking is desired, proportionately less meta crosslinker or precursors can be used.

The same considerations apply to the meta activator. That is to say, the amount of meta activator needed to achieve complete meta crosslinking is 100% on a molar basis, based on the amount of benzyl groups in the polymer. Therefore, the amount of meta activator to be included in the system, if any, should be the same on a molar basis as the amount of crosslinking desired.

In those situations in which the polar benzyl polymer is activated for meta crosslinking by modifying its ortho and/or meta substituents, the amount of hexa or analog used should also be sufficient to achieve the degree of crosslinking desired based on the stoichiometry of the system. That is to say, where complete meta crosslinking is desired, the amount of hexa or analog added should be sufficient to supply enough ammonia to modify all of the ortho and para substituents in the polar benzyl polymer. Where less than complete meta crosslinking is desired, a corresponding less amount of hexa or analog can be used.

In some cases, the amount of meta crosslinking that occurs will be less than 100% of theoretical. If so, the amount of meta crosslinker, meta crosslinker precursor, meta activator and/or hexa may need to be increased accordingly to account for this deficiency. The amount of this increase that is necessary can be easily determined by routine experimentation, especially in view of the working examples given below.

### Reaction Systems

The inventive meta crosslinking reaction can carried out simply by combining the reactants together at a temperature which is high enough for the reaction to occur. Other than this, there is no apparent constraint on the manner or mode in which this reaction can be carried out.

So, for example, the inventive meta crosslinking reaction can be carried out neat (i.e., without admixture with or dilution by a solvent, carrier or other medium) by melting the polar benzyl polymer to be crosslinked.

In addition, the inventive meta crosslinking reaction can be carried out by dissolving the polar benzyl polymer in a suitable liquid solvent. In this regard, there is no real constraint on the nature of the liquid that can be used for this purpose, so long as it is capable of dissolving the polar benzyl polymer being crosslinked. Examples of suitable solvents which can be used for this purpose include the short chain monohydric alcohols, e.g., methanol, ethanol, n-propanol, isopropanol, n-butanol, isobutanol, etc., the long chain (C₁₀+) monohydric alcohols, diols having 2 to 20 or more carbon atoms such as 1,4-butane dial, polyhydric alcohols having three or more hydroxyl groups such as glycerol, etc., amino compounds such as alkyl amines including cyclic compounds such as cyclohexyl amine, aniline, etc. In some instances, it is desirable to include water as a co-solvent, as this provides a more effective solvent system.

Solvent systems containing 50-95 wt. % methanol, ethanol or both, and especially 65-90 wt. % or even 75-85 wt. % methanol, ethanol or both, with the balance being water, have been found to be especially effective for this purpose.

The inventive meta crosslinking reaction can also be carried out in aqueous dispersion, i.e., with the polar benzyl polymer dispersed in water or other aqueous liquid, as further discussed below. Hot water is especially interesting for this purpose.

Regardless of the particular system used, the other ingredients of the reaction, e.g., the meta crosslinker, transition metal source compound, rare earth source compound, etc., need not be dissolved in the reaction medium. See, for example, the following working examples which show that oxides and inorganic compounds insoluble in the particular reaction system employed can be used as the meta crosslinker, transition metal source compound, and rare earth source compound in these reaction systems.

Although there appears to be no real constraint on the way the inventive meta crosslinking reaction can be carried out, certain approaches have been found to be convenient.

For example, when an organic phase reaction is being used to form an organic meta crosslink in a molten polar benzyl polymer, it is most convenient to melt the polar benzyl polymer first and then add the meta activator to the molten polymer, although the meta activator can be added before the polymer is melted. The mixture is then allowed to react to activate the meta carbon atoms of the polymer, preferably with continued mixing and heating to maintain the polymer in molten form. Reaction times on the order of about 3 to 20 minutes, more typically about 5 to 15 or even 7 to 10 minutes, have been found suitable for this purpose.

The organic meta crosslinker can then be added and the composition so obtained allowed to react (meta crosslink) for a suitable period of time, e.g., about 5 to 20 minutes, more typically about 6 to 14 or even 8 to 12 minutes, preferably with continued heating and mixing. After meta crosslinking is complete, the polymer can be recovered and used as is. Normally, however, the meta crosslinked polymer will be further reacted with additional aldehyde such as hexa or analog to complete ortho and para crosslinking and produce a “B-stage” resin, i.e., a fully cured polymer which differs from an otherwise identical conventionally prepared B-stage resin in that its meta positions are crosslinked as well.

In another convenient approach for forming an organic crosslink in a thermoplastic polar benzyl polymer, the polymer is dissolved in an aqueous solvent system including a water miscible organic cosolvent, after which a meta activator is added to the system and the mixture so obtained mildly heated for a time long enough for the polar benzyl polymer to become meta activated. Temperatures on the order of about 120° F. (˜49° C.) to 220° F. (˜104° C.), more typically about 135° F. (˜57° C.) to 185° F. (˜85° C.). more typically about 150° F. (˜60° C.) to 170° F. (˜77° C.) have been found to be suitable, as have heating times of 3 to 20 minutes, more typically 5 to 15 or even 7 to 10 minutes.

The organic meta crosslinker can then be added, and the composition so obtained allowed to react to form the desired meta crosslinks. Normally this can be done by simple mixing of the reaction system to insure intimate contact of all ingredients while maintaining the reaction system within the above temperature ranges, preferably at the same temperature used for meta activation. Reaction times on the order of about 2 to 10 minutes, more typically about 3 to 8 or even 4 to 6 minutes, have been found to be suitable for this purpose. After meta crosslinking is complete, the polymer can be recovered and used as is or reacted further to form a fully cured “B-stage” polymer in the same manner as discussed above.

The easiest way to form an inorganic crosslink in a thermoplastic polar benzyl polymer is to dissolve the polymer in an aqueous solvent system including an organic water miscible cosolvent, in the manner described above, and then to activate the dissolved polymer for meta crosslinking by treating the polymer to insure that its ortho and para substituents are, or assume, an electronegative character. For example, a novolac resin can be dissolved in such an aqueous solvent system, after which a suitable amount of hexa can be added and the mixture so obtained allowed to react for meta activation with continued mixing and suitable heating. Reaction temperatures on the order of about 100° F. (˜38° C.) to 200° F. (˜93° C.), more typically about 125° F. (˜52° C.) to 175° F. (˜79° C.), even more typically about 140° F. (˜60° C.) to 160° F. (˜71° C.), have been found to be suitable, as have reaction times on the order of 10 to 35 minutes, more typically 15 to 30 or even 18 to 22 minutes.

Once the polar benzyl polymer has been activated, a rare earth source compound can be added and the mixture so obtained heated at the same temperature range indicated above, preferably the same temperature, for a suitable period of time, preferably with continued mixing, to initiate formation of the inorganic crosslink. Reaction times on the order of 5 to 15 minutes, more typically 8 to 12 or even ˜10 minutes have been found to be suitable for this purpose.

Thereafter, the transition metal source compound or compounds for forming the remaining portions of the inorganic crosslink can be added and the mixture so obtained allowed to react for an additional suitable period of time, preferably at the same temperature and with continued mixing for completing the meta crosslinking reaction. Reaction times on the order of 5 to 40 minutes, more typically 10 to 30 or even 15 to 25 minutes have been found to be suitable for this purpose.

The meta crosslinked polymer so obtained can be used as is or reacted further to form a fully cured “B-stage” polymer in the same manner as discussed above. This further cure can be done in at least two different ways.

In one approach, hexa or other conventional crosslinker can be added and the system at this time and the system then heated to effect final B-stage cure in a conventional manner. In another approach, an excess of hexa or analog is included in the reaction system during the meta activation reaction as described above, this excess being sufficient not only to meta activate the polar benzyl polymer but also to effect full B-stage cure of polymer. When adopting this approach, the B-stage curing reaction can be carried out immediately following the meta crosslinking reaction described above simply by increasing the temperature of the reaction system slightly and continuing to heat the reaction system until full B-stage cure is achieved. Temperatures on the order of about 200° F. (˜93° C.) to 300° F. (˜149° C.), more typically about 225° F. (107° C.) to 275° F. (˜135° C.). more typically about 240° F. (˜116° C.) to 260° F. (˜427° C.) have been found to be suitable, as have heating times of 0.5 to 10 minutes, more typically 1 to 5 or even ˜3 minutes.

The inventive crosslinking reaction can also be carried out in aqueous dispersion by forming an aqueous dispersion or emulsion of the polar benzyl polymer. If so, generally the same approach as described above in connection with a solution reaction system can be used in the sense that a suitable dispersion or emulsion of the polymer is formed first followed by adding the meta activator with heating to meta activate the polymer and then adding the meta crosslinker, or one or more source compounds capable of reacting to form the meta crosslinker, with heating to cause the meta crosslinks to form. For this purpose, generally the same reaction times and temperatures as described above in connection with the solution reaction system can be used.

Incidentally, the above reaction conditions have been found appropriate for laboratory scale operations, i.e., reactions carried out in the relatively small scale used in most research laboratories. When these preparations are repeated in commercial scale operation, which are typically much larger, the reaction conditions may change accordingly. For example, similar reactions when carried out in commercial scale typically take about twice as long to complete as the same reaction when carried out on a laboratory scale. Continuous rather than batch operation can also impact reaction times and temperatures. Based on the above description as well as the following working examples, skilled polymer chemists should have no difficulty selecting the particular reaction conditions to use for carrying out particular embodiments of the inventive meta crosslinking reaction in different sizes (scales) and different reaction modes (neat, solution, emulsion, batch, continuous, etc.).

### Resin Coated Proppants

The meta crosslinked polar benzyl polymers of this invention can be used for any utility that their conventional counterparts (i.e., the same polymer but not crosslinked at its meta positions) can be used. Thus, they can be used to make a wide variety of different products including building and construction products, electric and electronic devices, furniture and furnishings, consumer and industrial articles, etc.

One such utility is in the manufacture of resin coated proppants. Propping agents or “proppants” are particulate materials which are introduced into subterranean formations to increase oil or gas production. Generally, this is done by “fracturing,” i.e., a process in which a viscous fracturing fluid is charged into the subterranean formation through a wellbore at extremely high pressures. This causes fissures to form in the subterranean formation, which fissures provide pathways for the oil and/or gas in the formation to escape once the fracturing operation is complete. To maintain these fissures in a propped open condition once the high fracturing pressure is released, proppant particles are included in the fracturing fluid which are carried into these fissures as part of the fracturing operation. Upon release of the fracturing pressure, the proppants settle and form a “pack” which serves to hold the subterranean formation open. See, in general, U.S. Pat. No. 6,328,105 to Betzold and U.S. Pub. App. No. 2005/0194141 to Sinclair et al., the disclosures of which are incorporated herein by reference.

Compressive earth stresses (“closure stresses”) encountered in subterranean formations subjected to fracturing can range from 500 psi to 25,000 psi or even higher, depending upon the depth of the fracture. Accordingly, the proppant selected for a particular subterranean formation must be strong enough to resist the compressive earth forces in that formation, thereby keeping the fissures open and allowing fluid flow therethrough. Thus, sand proppant particles are generally used where closure stresses are up to about 6,000 psi, ceramics are generally used at closure stresses up to about 15,000 psi, and bauxite is generally used at closure stresses greater than about 15,000 psi.

A significant advance in proppant technology is the addition of resin coatings. A resin-coated proppant generally has a greater crush resistance than an otherwise identical uncoated proppant and can be used at greater depths or may be used at the same depth with increased relative conductivity. For example, uncoated sand can be used at closure stresses up to about 6,000 psi. In contrast, resin coated sand proppants can be used at closure stresses up to about 10,000 psi. The coating also serves to trap free fines from fragmented or disintegrated substrates under high closure stress. See the following patents for a fuller disclosure of this technology: U.S. Pat. No. 3,659,651 to Graham, U.S. Pat. No. 3,929,191 to Graham, et al., U.S. Pat. No. 5,218,038 to Johnson, et al., U.S. Pat. No. 5,422,183 to Sinclair, et al., and U.S. Pat. No. 5,597,784 to Sinclair, et al. See, also, U.S. Pat. No. 6,380,138 to Ischy, et al., and U.S. Pat. No. 5,837,656 to Sinclair, et al.

In accordance with another feature of this invention, the inventive meta crosslinked polar benzyl polymers described above are used to make resin coated proppants. In accordance with this aspect of the invention, it has been found that these resin coated proppants exhibit better overall proppant properties, particularly crush strength, porosity and conductivity, than their conventional counterparts, i.e., an otherwise identical resin coated proppant made with an otherwise identical resin coated proppant except that its reins coating is not meta crosslinked.

Any particulate material which has been used in the past, or which may be used in the future, as a proppant can be used as the proppant particle substrate of the inventive resin coated proppants. Thus, naturally occurring organic products, silica based products, ceramics, metallics and synthetic organic materials can be used for this purpose. Mixtures of these materials can also be used.

Examples of naturally occurring organic products that can be used for this purpose include, but are not limited to, nut shells such as walnut, brazil nut, and macadamia nut, as well as fruit pits such as peach pits, apricot pits, olive pits, and any resin impregnated or resin coated version of these.

Examples of silica based material that can be used for this purpose include, but are not limited to, glass spheres and glass microspheres, glass beads, silica quartz sand, sintered Bauxite, and sands of all types such as white or brown. Typical silica sands suitable for use include Northern White Sands (Fairmount Minerals, Chardon, Ohio), Ottawa, Jordan, Brady, Hickory, Arizona, and Chalford, as well as any resin coated version of these sands. In the case of silica fibers being used, the fibers can be straight, curved, crimped, or spiral shaped, and can be of any grade, such as E-grade, S-grade, and AR-grade. Preferably, the silica proppants used are silica sands.

Examples of ceramic materials that can be used for this purpose include, but are not limited to, ceramic beads; spent fluid-cracking catalysts (FCC) such as those described in U.S. Pat. No. 6,372,378, which is incorporated herein in its entirety; ultra lightweight porous ceramics; economy lightweight ceramics such as “Econoprop” (Carbo Ceramics, Inc., Irving, Tex.); lightweight ceramics such as “Carbolite”; intermediate strength ceramics such as “Carboprop” or “Interprop” (all available from Carbo Ceramics, Inc., Irving, Tex.); and high strength ceramics such as “CarboHSP”, “Sintered Bauxite” (Carbo Ceramics, Inc., Irving, Tex.), as well as any resin coated or resin impregnated versions of these, such as described above.

Examples of metallic materials that can be used for this purpose include, but are not limited to, aluminum um shot, aluminum pellets, aluminum needles, aluminum wire, iron shot, steel shot, and the like, as well as any resin coated versions of these metallic proppants.

Examples of synthetic organic materials that can be used for this purpose include, but are not limited to, plastic particles or beads, nylon beads, nylon pellets, SDVB (styrene divinyl benzene) beads, carbon fibers such as Panex carbon fibers from Zoltek Corporation (Van Nuys; Calif.), and resin agglomerate particles similar to “FlexSand MS” (BJ Services Company, Houston, Tex.), as well as resin coated versions thereof.

The particle size of the proppant particle substrate of the inventive resin coated proppant is not critical and any conventional particle size can be used. For example, particle sizes on the order of about 4 to about 200 mesh based on USA Standard Testing Screens (i.e., 4 to 200 screen openings per inch corresponding to screen openings of about 0.18 inch to about 0.003 inch in width) can be used. Particle sizes on the order of about 4 mesh (4750 microns) to about 200 mesh (75 microns) are more interesting. Particle size distributions on the order of 6/12, 8/16, 12/18, 12/20, 16/20, 16/30, 20/40, 30/50, 40/70 and 70/140 mesh are contemplated, while any desired size distribution can be used, such as 10/40, 14/20, 14/30, 14/40, 18/40, and the like, as well as any combination thereof (e.g., a mixture of 10/40 and 14/40). The preferred mesh size, in accordance with the present invention, is 20/40 mesh. As well understood in the art, a “20/40 mesh” particle size distribution means that substantially all of the particulate material in the batch being referred to falls though a standard 20 mesh screen but is retained by a standard 40 mesh screen.

### Calcining the Meta Crosslinked Polymer

In accordance with another feature of this invention, it has been found that a new material having an unusual combination of properties can be obtained by heating the inventive meta crosslinked polar benzyl polymers under conditions which are severe enough to cause the polymer to decompose, provided that the polymer is made with inorganic crosslinks. In particular, it has been found that a new material, hereinafter referred to as an organometallic composite, exhibiting an extraordinarily high 0.2% Yield Strength, e.g., as high as 22 ksi or even higher, as well as strain hardening (work hardening) can be obtained by this approach. Strain hardening is a property seen in certain metal alloys in which the alloy becomes stronger and harder in response to mechanical deformation.

In order to form this new material, a meta crosslinked polymer as described above in which the meta crosslinks are inorganic is heated under conditions which are severe enough to decompose the polymer. This can be done either in the presence of air or other oxygen containing gas (calcination) or in absence of oxygen (destructive distillation). Heating at 400° C. to 600° C. for one hour has been found effective for calcination as well as for destructive distillation.

An especially interesting use for this feature of this invention is in manufacturing new proppants materials having combinations of properties not seen before. In particular, it has been found in accordance with this aspect of the invention that a new organometallic proppant exhibiting the extraordinarily high crush strengths of certain specially prepared synthetic ceramic proppants, e.g., 22 ksi, as well as strain hardening (work hardening) can be obtained by providing a conventional proppant particle substrate with a surface layer or coating composed of this new material.

In order to produce this new organometallic proppant, a resin coated proppant is made in which the resin coating is formed from a meta crosslinked polar benzyl polymer of this invention in which the meta crosslinks are inorganic. This can be done in any convenient way as described above, for example, by making the meta crosslinked polar benzyl polymer first and then combining it with the proppant particle substrate second, or by combining the proppant particle substrate with one or more ingredients or precursors forming the meta crosslinked polar benzyl polymer and then meta crosslinking this polymer in situ in the presence of the proppant particle substrate.

In those embodiments in which the polymer is meta crosslinked first, it is desirable to combine the polymer with the proppant particle substrate before it is fully crosslinked, i.e., before the polymer is subjected to a B-stage cure, as this is not only easier from a procedural standpoint but also insures complete coating of the substrate particle with the polymer.

In addition, it may also be desirable in this instance to include an excess of the source compounds forming the inorganic crosslink, i.e., the rare earth source compound and the transition metal source compound, as it has been found that this approach may increase the strength and strain hardening property of the proppant material ultimately obtained. Excesses on the order of 1.5 to 10 times on a weight basis (i.e., the weight of the inorganic source compounds used is 1.5 to 10 times greater than the amount of polar benzyl polymer used), are contemplated. Excess of about 2 to 7 or even 3 to 4 times are more interesting, although excesses on the order of at least about 2, at least about 3, at least about 4, at least about 5, at least about 7, at least about 10, and at least about 15 times are also contemplated.

Once this resin coated proppant is formed, it is then heated under conditions severe enough to decompose the polymer and produce the new organometallic proppant of this invention, this new organometallic proppant being composed of a proppant particle substrate carrying a surface layer of the decomposition residue produced by this heating operation. Heating to decompose the meta crosslinked polymer and produce the new proppant material can be done in the same way as described above, i.e., by heating in the presence or absence of air or other oxygen containing gas at 400° C. to 600° C. for one hour or so.

The new organometallic proppant material made in this way can be used as is. Alternatively, it can also be provided with an outer coating comprising a fully or partially cured conventional polymer coating, i.e., a coating made from a polymer resin that has traditionally been used for making resin coated proppants, to provide even better crush strengths and flow-back control. Examples of such polymers include bisphenols, bisphenol homopolymers, blends of bisphenol homopolymers with phenol-aldehyde polymer, bisphenol-aldehyde resins and/or polymers, phenol-aldehyde polymers and homopolymers, modified and unmodified resoles, phenolic materials including arylphenols, alkylphenols, alkoxyphenols, and aryloxyphenols, resorcinol resins, epoxy resins, novolak polymer resins, novolak bisphenol-aldehyde polymers, and waxes, as well as the precured or curable versions of such resin coatings.

### WORKING EXAMPLES

In order to more thoroughly describe this invention, the following working examples are provided.

### Example 1

### Organic Crosslink—Neat Reaction System

500 gm of a novolac resin was melted in a 5 liter container by heating at 300° F. for approximately 15-20 minutes.

8 gms of a meta activator comprising powdered cerium acetate was then added. While maintaining the temperature of the reaction system at 300° F., the composition so obtained was blended in a high speed Ross Mixer equipped with a cowl blade at 1100 rpm for about 7 to 10 minutes to insure homogeneous mixing.

20 gm of a meta crosslinker comprising neopentyl (diallyl)oxy tri (m-amino) phenyl zirconate, manufactured by Kenrich Petrochemical, Inc, having the following formula

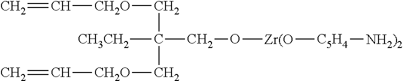

was then added and blending continued at 300° F. After approximately 10 minutes, a significant increase in viscosity was visually observed, thereby indicating that meta crosslinks began to form. Blending was continued at 300° F. for an additional 5 minutes to insure complete meta crosslinking, after which a reaction product in the form of a viscous gel was recovered.

A small sample of this viscous gel reaction product was analyzed by C₁₃ and Proton Nuclear Magnetic Spectroscopy (C₁₃ NMR), thereby confirming the formation of meta linkages.

The remainder of the viscous gel reaction product obtained above was transferred into a 250 ml aluminum cup preheated to 300° F., after which 14 wt % hexa (hexamethylenetetramine) based on the weight of this viscous gel reaction product was added. Approximately 3 minutes after hexa addition, the mixture solidified as result of partial aldehyde crosslinking at the ortho and para positions of the novolac resin, thereby producing a modified solid “A-stage” resin, i.e., a solid “A-stage” resin modified by having the meta positions of its phenol groups crosslinked by the meta crosslinkers of this invention. The modified A-stage resin so obtained was then removed from the cup into a metallic pan and allowed to cure further at 350° F. for an additional 10 minutes to ensure complete aldehyde crosslinking, thereby producing a fully cured “B-stage” resin made in accordance with this invention, i.e., a fully cured “B-stage” resin modified by having the meta positions of its phenol groups also crosslinked by the meta crosslinkers of this invention.

Portions of this fully cured “B-stage” resin made in accordance with this invention were then analyzed for 0.2% Yield Strength by ASTM-E21 and for Ultimate Tensile Strength by ASTM-E8.

### Comparative Example A

A conventionally prepared fully cured B-stage novolac resin product was made by repeating Example 1, except that the meta activator and meta crosslinker used in Example 1 were omitted.

The 0.2% Yield Strength and Ultimate Tensile Strength of this product were found to be significantly less than that of the product of Example 1.

The significantly greater 0.2% Yield Strength and Ultimate Tensile Strength of the fully cored modified B-stage reaction product of the above Example 1 relative to that obtained in this Comparative Example A shows that these two reaction products are substantially different from one another in terms of chemical structure. Moreover, the spectral data obtained in Example 1 strongly indicates that significant amounts of chemical substitution occurred at the meta positions of the phenol groups in the novolac resin of Example 1, before final cure of this resin occurred as a result of the hexa addition. Together, these results confirm that significant meta crosslinking occurred in of this novolac resin occurred, i.e., that a substantial number of meta crosslinks formed between adjacent phenol groups in the fully cured modified B-stage reaction product of the above Example 1.

### Example 2

### Organic Crosslink—Solution Reaction System

500 gm of a novolac resin was dissolved in 850 ml of an aqueous solvent system containing 80 wt. % methanol, and 20 wt. % water in a 3 liter container at room temperature.

After heating the solution so obtained to 160° F., 10 gm of a meta activator comprising powdered cerium acetate was added and the mixture so obtained blended in Ross Mixer at 1100 rpm for 7 to 10 minutes while maintaining the temperature at 160° F. to activate the meta positions of the novolac resin.

20 gm of a meta crosslinker comprising powdered neopentyl (diallyl)oxy tri (m-amino) phenyl zirconate, manufactured by Kenrich Petrochemical, Inc, was then added and blended for approximately 10 minutes until a visual increase in viscosity was observed, indicating that meta linkages had formed. Heating was stopped and the meta crosslinked resin was allowed to solidify into a viscous gel for further use.

A small portion of this viscous gel was analyzed by C₁₃ Nuclear Magnetic Spectroscopy (C₁₃ NMR) in the manner described above in connection with Example 1, thereby confirming the formation of meta linkages.

The remainder of the meta crosslinked resin gel described above was then transferred to a 250 ml aluminum cup preheated to 300° F. 14 wt % hexa (hexamethylenetetramine) was then added with mixing, and the mixture so obtained heated to 300° F. for an additional 3-5 minutes to achieve partial aldehyde crosslinking of the ortho and para positions of the phenol groups in the resin, thereby producing a modified solid “A-stage” resin, i.e., a solid “A-stage” resin modified by having the meta positions of its phenol groups crosslinked by the meta crosslinkers of this invention.

This modified solid “A-stage” resin, after transferring to a metallic pan, was heated at 350° F. for an additional 2 hours to ensure complete crosslinking, thereby forming a fully cured “B-stage” resin made in accordance with this invention, i.e., a fully cured “B-stage” resin modified by having the meta positions of its phenol groups also crosslinked by the meta crosslinkers of this invention.

The 0.2% Yield Strength and Ultimate Tensile Strength of this resin product, when measured in the same way as in Example 1, were found to be significantly greater than that of the product of Comparative Example A.

Example 2 shows that the inventive meta crosslinking reaction can be carried out in solution in the presence of water as well as neat.

### Example 3

### Organic Crosslink—Neat Reaction System

Example 1 was repeated, except that the meta activator was composed of 10 gm of powdered lanthanum nitrate and final cure of the resin was accomplished by heating at 350° F. for 2 hours.

C₁₃ and Nuclear Magnetic Spectroscopy (C₁₃ NMR) carried out in the same manner as in Example 1 confirmed that meta linkages had formed. Moreover, the 0.2% Yield Strength and Ultimate Tensile Strength of the fully cured “B-stage” resin product of this example, when analyzed by the same analytical techniques used in Example 1, were found to be significantly greater than that of the product of Comparative Example A.

Example 3 shows that inorganic meta activators are just as effective as organic meta activators.

### Example 4

### Inorganic Crosslink—Solution Reaction System

150 gm of a novolac resin was dissolved in 1000 ml of an aqueous solvent system containing 80 wt. % methanol and 20 wt. % water in a 4 liter container at room temperature.

12 gm hexa (hexamethylenetramine) was then added, and mixture so obtained heated to 150° F. to activate the novolac resin for meta crosslinking by forming a resin-hexa intermediate in accordance with known technology in which the methylene linkages of the resin are replaced with highly electronegative amino groups. Heating was continued for about 10 minutes, at which time the reaction system was transformed into a viscous gel, thereby indicating that the desired intermediate had formed.

1 gm of a rare earth metal source compound in the form of powdered lanthanum oxide was then added to this gel intermediate and the mixture so obtained mixed for an additional 10 minutes at 150° F. to begin formation of the desired inorganic meta crosslinks.

820 gms of a transition metal source compound in the form of powdered ammonium antimonate was then added, and the mixture so obtained blended in a Ross Mixer at 3000 rpm for completing the inventive meta crosslinking reaction. After 20 minutes, a viscous gel was obtained, thereby indicating that the desired inorganic meta crosslinks had formed.

A small portion of this viscous gel was analyzed by C₁₃ Nuclear Magnetic Spectroscopy (C₁₃ NMR) in the manner described above in connection with Example 1, thereby confirming the formation of meta linkages.

The viscous reaction system so obtained was then heated to 250° F. for an additional 3 minutes to effect final cure of the polymer, thereby producing a fully-cured solid B-stage resin product.

The 0.2% Yield Strength and Ultimate Tensile Strength of the fully-cured solid resin product so obtained were found to be substantially higher than those obtained from similar novolac resins made without including the above meta activator and meta crosslinker, thereby further confirming that meta crosslinks were obtained.

Example 4 shows that inorganic meta crosslinks can also be formed by the inventive meta crosslinking reaction and further that the polar benzyl polymer being crosslinked can be activated by making its ortho and para substituents electronegative in nature, rather than chemically affecting the phenol group of the polymer as in Example 1.

### Example 5

### Inorganic Crosslink—Solution Reaction System

Example 4 was repeated except that a mixture of transition metal source compounds was used to form the meta crosslink, this mixture being composed of 600 gm molybdenum disulfide, 200 gm zinc pyrophosphate and 8 gm aluminum phosphate. In addition, blending of the reaction system was done for 30 minutes at 3500 rpm.

The 0.2% Yield Strength and Ultimate Tensile Strength of the fully-cured solid resin product so obtained were found to be significantly greater than the control sample referred to in Example 4, thereby again illustrating that significant meta crosslinking was obtained.

Example 5 shows that a variety of different transition metals are useful in forming the inorganic meta crosslinks of this invention and further that mixtures of these transition metals can be used for this purpose.

### Example 6

### Organometallic Proppant

Example 4 was repeated to produce a meta crosslinked novalac resin made with inorganic cross links in the form of a viscous gel.

The gel was then injected into EIRICH model ROV-24 industrial mixer which had previously been charged with a heated conventional sand proppant and the composition so obtained mixed until a resin coated proppant product was obtained. This resin coated proppant product was then charged into a heated (200° F.) continuous air-swept mixer to break apart any aggregates or lumps that had form and partially dry out the mixture.

The resin coated proppant so obtained was then continuously charged into a rotary kiln maintained at 400° C. to 600° C. with a dwell time of about 1 hour from entry to exit to calcine the resin coating, thereby producing a new organometallic proppant comprising a sand proppant particle substrate carrying a surface coating comprising an inorganic meta crosslinked polar benzyl polymer decomposition residue.

The 0.2% Yield Strength and Ultimate Tensile Strength of this organometallic proppant demonstrated that a new proppant material had been formed.

Example 6 shows that organometallic proppants made by calcining a resin coated proppant in which the resin coating is made from the inventive meta crosslinked polar benzyl polymer in which the meta crosslinks are inorganic exhibits a 0.2% Yield Strength and an Ultimate Tensile Strength as good as the best synthetic proppants currently available.

Although only a few embodiments of this invention have been described above, it should be appreciated that many modifications can be made without departing from the spirit and scope of the invention. All such modifications are intended to be included within the scope of this invention, which is to be limited only by the following claims:

1-42. (canceled)

43. A resin coated proppant comprising a proppant particle substrate and a polymer resin coating on the proppant particle substrate, wherein the polymer resin coating comprises the reaction product obtained by heating a mixture comprising
(a) a polar benzyl polymer incompletely crosslinked at its ortho and para positions,
(b) at least one transition metal crosslinker comprising
(i) an organic crosslinker comprising an organometallic compound containing a transition metal in a valence state of at least 4, or
(ii) an inorganic crosslinker comprising the reaction product obtained in situ by the reaction of a transition metal source compound in the form of an inorganic oxide or salt containing a transition metal in a valence state of at least 2 and a rare earth source compound in the form of a rare earth oxide, nitrate, acetate, citrate or C₁-C₈ alkoxide, and
(c) at least one activator comprising
(i) an oxide or salt of at least one rare earth element which also contains at least one of O, N and S, or
(ii) a compound capable of liberating formaldehyde and ammonia when heated.

44. The resin coated proppant of claim 43, wherein the transition metal crosslinker is an organometallic compound.

45. The resin coated proppant of claim 44, wherein the polar benzyl polymer is a phenol aldehyde resin.

46. The resin coated proppant of claim 45, wherein the transition metal crosslinker includes at least two organic groups, with each organic group being attached to the transition metal by one or more single (sigma) bonds via an intermediate oxygen atom for each single (sigma) bond.

47. The resin coated proppant of claim 46, wherein the transition metal crosslinker contains a transition metal and at least four organic moieties each being attached to the transition metal by one single (sigma) bond via an intermediate oxygen atom.

48. The resin coated proppant of claim 45, wherein the transition metal crosslinker is a titanate, zirconate, aluminate or mixtures thereof.

49. The resin coated proppant of claim 48, wherein the activator is at least one of an oxide or salt of at least one rare earth element containing at least one of O, N and S.

50. The resin coated proppant of claim 49, wherein the activator is selected from the group consisting of acetates, formates, citrates, nitrates, phosphates, phosphites, sulfates and sulfites.

51. The resin coated proppant of claim 50, wherein the activator is at least one of cerium acetate, cerium nitrate, lanthanum acetate, lanthanum nitrate, thorium acetate and thorium nitrate.

52. The resin coated proppant of claim 45, wherein the polymer resin coating further comprises sufficient aldehyde or compound capable of releasing aldehyde on heating to enable the polar benzyl polymer to cure into a thermoset resin.

53. The resin coated proppant of claim 52, wherein the polymer resin coating further comprises sufficient hexamethylenetetramine to enable the polar benzyl polymer to cure into a thermoset resin.

54. The resin coated proppant of claim 52, wherein the transition metal crosslinker is a titanate, zirconate, aluminate or mixtures thereof, and further wherein the activator is at least one of an oxide or salt selected from the group consisting of acetates, formates, citrates, nitrates, phosphates, phosphites, sulfates and sulfites.

55. The resin coated proppant of claim 54, wherein the transition metal crosslinker is a titanate, zirconate or mixtures thereof, and further wherein the activator is at least one of cerium acetate, cerium nitrate, lanthanum acetate, lanthanum nitrate, thorium acetate or thorium nitrate.

56. The resin coated proppant of claim 45, wherein the polar benzyl polymer has cured into a thermoset resin.

57. The resin coated proppant of claim 56, wherein the transition metal crosslinker is a titanate, zirconate, aluminate or mixtures thereof, and further wherein the activator is at least one of an oxide or salt selected from the group consisting of acetates, formates, citrates, nitrates, phosphates, phosphites, sulfates and sulfites.

58. The resin coated proppant of claim 43, wherein the transition metal crosslinker is inorganic and comprises the reaction product obtained in situ by the reaction of an inorganic oxide or salt containing a transition metal having an atomic number of 13-51 or 72-84 and a rare earth source compound.

59. The resin coated proppant of claim 58, wherein the rare earth element of the rare earth source compound is at least one of lanthanum, cerium and thorium, and further wherein the transition metal is at least one of antimony, molybdenum, zinc and aluminum.

60. The resin coated proppant of claim 58, wherein the polar benzyl polymer is a phenol aldehyde resin.

61. The resin coated proppant of claim 60, wherein the phenol aldehyde resin contains methylene linkages, and further wherein the phenol aldehyde resin is activated by forming an intermediate in which these methylene linkages are replaced with amino linkages.

62. The resin coated proppant of claim 61, wherein the polymer resin coating is obtained by the reaction of a transition metal source compound, a the rare earth source compound and this intermediate.

63. The resin coated proppant of claim 62, wherein the rare earth source compound contains one of lanthanum, cerium and thorium, and further wherein the transition metal is at least one of antimony, molybdenum, zinc and aluminum.

64. The resin coated proppant of claim 63, wherein the rare earth source compound is an oxide, and further wherein the transition metal source compound is at least one of an antimonate, molybdate and an aluminate.

65. The resin coated proppant of claim 64, wherein the rare earth source compound is lanthanum oxide and the transition metal source compound is an antimonate.

66. The modified proppant obtained by heating the resin coated proppant of claim 58 to decompose its polymer resin coating.

67. The modified proppant obtained by heating the resin coated proppant of claim 62 to decompose its polymer resin coating.

68. The modified proppant obtained by heating the resin coated proppant of claim 63 to decompose its polymer resin coating.

69. The modified proppant obtained by heating the resin coated proppant of claim 65 to decompose its polymer resin coating.
